(19) United States
(12) Patent Application Publication
(10) Pub. No.: US 2005/0123117 A1
(43) Pub. Date: Jun. 9, 2005

(54) Method for providing third-party call control reuse of telephony features

(76) Inventor: Robert S. Stockdale, Boca Raton, FL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/964,864

(22) Filed: Oct. 14, 2004

Related U.S. Application Data
(60) Provisional application No. 60/511,781, filed on Oct. 16, 2003.

(51) Int. Cl. H04M 3/42

(52) U.S. Cl. 379/207.02; 379/207.11

(57) ABSTRACT

Third-party call control functionality from a user's application platform makes use of existing feature logic and feature interactions within the telephony switch controlling the telephonic device being proxied. A PC coupled to a web-based server and a phone are provided at the user end. An interface includes a server. At the switch end, there is signaling proxy equipment such as a CSTA Manager and a local signaling manager. A call processing core is made up of a Call Engine that may include a 3^{rd} Party Make Call Control (3PCC) API. Call services are provided through the switch, which may include a CSTA service as well as other services.

The present application claims priority from U.S. Provisional Patent Application Ser. No. 60/511,781 filed on Oct. 16, 2003, in the US Patent Office the entire contents of which are incorporated by reference herein in its entirety.

### BACKGROUND

1. Field of the Invention

The present invention relates to a method, system and apparatus providing third-party call control functionality from a user's application platform and, more particularly, providing third-party call control functionality from a user's application platform which makes use of existing feature logic and feature interactions within the telephony switch controlling the telephonic device being proxied.

2. Related Information

Customers expect that features and their interactions to be the same, regardless of whether they are accessed or used in the traditional manner, such as by direct connection over a phone, or via contemporary means through a third party call control application. Such third party application may be hosted by a PC, PDA, laptop etc. However, the traditional systems were not equipped to port the particular customer features to these third party applications.

An approach to this problem provides an existing telephony feature via a third party call control application via a manual process. However, the manual process has proven difficult to implement and is time consuming to implement with integrity. This necessitated extensive design, coding, and verification testing, as well as additional efforts in subsequent releases of the software.

Another problem, is that each desired feature was reanalyzed, re-recoded, as well as retested for every release. As a result, the number of features provided in this manner were limited to a small selective number. Further, each feature added required the development of new software, thereby duplicating existing functionality.

In order to demonstrate the disadvantages of the inferior solution, a Siemens hiQ8000™ was added to an interface to an external, browser-based call control application (widely known as ComAssistant). One of the features offered was Call Hold. Initial effort estimates included development of a new “ComAssistant Call Hold” service in the hiQ to duplicate the existing Call Hold service. By analogy, any other features would need to be duplicated and tested for the third party application.

Clearly, this costs excessive time and money and is not a very elegant solution. Further, the number of features offered is limited, as each additional feature must be separately therefore provided. Not to mention that each feature requires effort to support.

What is needed is a solution that utilizes an existing feature via a third-party call control API. Certainly, a solution is need that is much easier, quicker, and cheaper than heretofore provided. Thus utilizing the initial infrastructure in place, use of each additional features could be provided with a minimal re-verification effort.

### OBJECTS & SUMMARY OF THE INVENTION

An object of the present invention is to provide third-party call control functionality from a user's application platform.

An object of the present invention is to provide third-party call control functionality from a user's application platform which makes use of existing feature logic and feature interactions.

An object of the present invention is to provide third-party call control functionality from a user's application platform which makes use of existing feature logic and feature interactions within the telephony switch controlling the telephonic device being proxied.

An object of the present invention is to provide third-party call control functionality from a user's application platform that is much easier, quicker, and cheaper than heretofore provided.

An object of the present invention is to provide third-party call control functionality from a user's application platform that utilizes the existing infrastructure.

An object of the present invention is to provide third-party call control functionality from a user's application platform that does not require reproducing the functionality and retesting the same.

The present invention provides a Computer Supported Telecommunications Application (CSTA) manager that receives call event from the external application. The CSTA manager sends a signal representative of the call event to an existing Signaling Manager (SM), requesting that it operate as though the SM had received it via a normal interface. The existing SM then controls the feature in the existing manner, allowing the existing feature segments in the call to operate in their normal manner.

With the present invention, there is provided rapid introduction of existing features under the control of a third-party proxy without necessitating feature rework, interactions rework, or re-verification of all feature combinations. This may includes APIs such as CSTA, TAPI, JTAPI, SIP, XML over SOAP, JAIN, and Parlay. Thus, the invention allows for the easy re-use of existing telephony features in third party call control applications. It leverages the feature work that has already been done within the switch.

### BRIEF DESCRIPTION OF THE DRAWINGS

FIG. 1 is a block diagram according to one embodiment of the present invention;

FIG. 2 is a call flow diagram according to one embodiment of the present invention;

FIG. 3 is a call flow diagram according to one embodiment of the present invention;

FIG. 4 is a call flow diagram according to one embodiment of the present invention;

FIG. 5 is a call flow diagram according to one embodiment of the present invention;

FIG. 6 is a call flow diagram according to one embodiment of the present invention;

FIG. 7 is a call flow diagram according to one embodiment of the present invention;

FIG. 8 is a call flow diagram according to one embodiment of the present invention;

FIG. 9 is a call flow diagram according to one embodiment of the present invention;

FIG. 10 is a call flow diagram according to one embodiment of the present invention;

FIG. 11 is a call flow diagram according to one embodiment of the present invention;

FIG. 12 is a call flow diagram according to one embodiment of the present invention;

FIG. 13 is a call flow diagram according to one embodiment of the present invention;

FIG. 14 is a call flow diagram according to one embodiment of the present invention;

FIG. 15 is a call flow diagram according to one embodiment of the present invention;

FIG. 16 is a call flow diagram according to one embodiment of the present invention;

FIG. 17 is a call flow diagram according to one embodiment of the present invention;

FIG. 18 is a call flow diagram according to one embodiment of the present invention;

FIG. 19 is a call flow diagram according to one embodiment of the present invention;

FIG. 20 is a call flow diagram according to one embodiment of the present invention; and

FIG. 21 is a call flow diagram according to one embodiment of the present invention.

### DETAILED DESCRIPTION OF THE PREFERRED EMBODIMENT

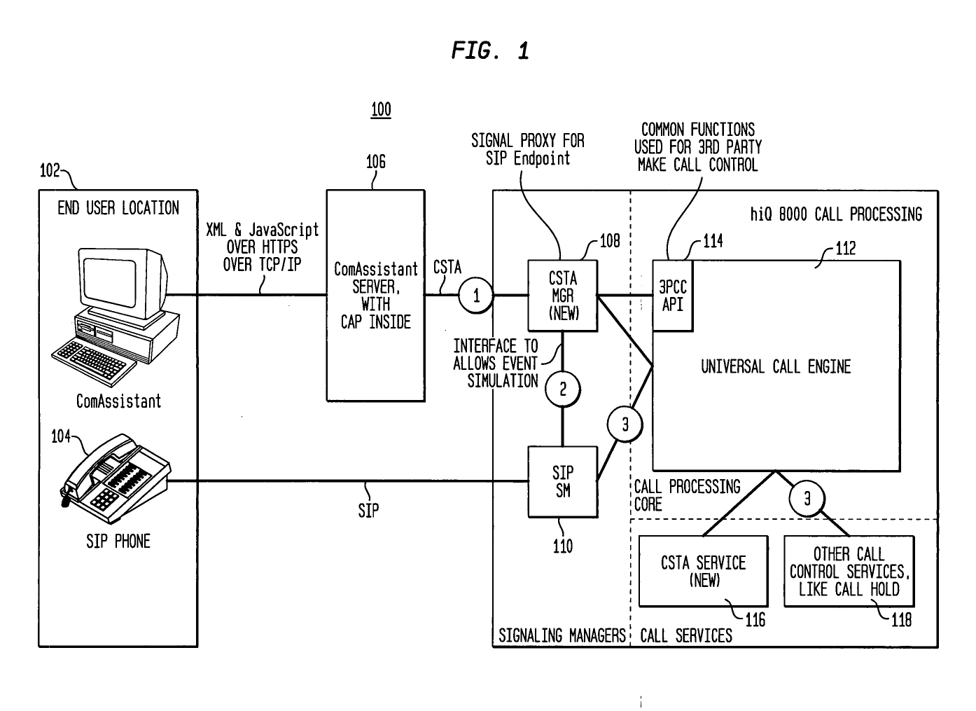

The inventive solution will now be explained within an existing environment with reference to FIG. 1. The environment may be, for example, any environment that pre-defines the inter-working mechanisms among Computing, Switching and Special Resource Functions independently from their physical implementations. In one aspect, the environment may be CSTA (Computer Supported Telecommunications Applications), a standard promulgated by the ECMA. Of course, the invention applies to any environment.

In the broader realm of Telecommunications, the present invention may exist within any supporting Telecommunications Network. In one example, the invention may be implemented as part of, or in conjunction with, a Softswitch. A type of Softswitch, known on the commercial market as the hiQ8000™ provided by Siemens™, may be utilized.

In order to facilitate the operation of the invention, the Softswitch may provide a native interface, such as an XML interface, for CTI application support. This may be in the form of an existing software application that includes an integrated web server, such as Apache Tomcat, that provides a web-based (HTML over HTTPS) telephone control interface to authorized users. The web-based interface, in conjunction with the telephony features supported by the Softswitch via the CSTA interface, provide the user with a method to control services on their desk telephone, and also provide limited mobility service, which permits the user to access features when working remotely.

The following figure shows, at a high-level, the architectural design 100 allowing for the inclusion of CSTA functionality within the Softswitch. As shown, at the end user location, is shown a Web-based client 102 and a phone 104. An interface includes a server 106 which may be a known server, such as the ComAssistant™ server provided by Siemens™, a Web-based application that helps busy subscribers to filter and route—in real time—voice calls and voice messages. At the switch end, there is shown signaling proxy equipment, or remote signaling manager, herein refered to as the CSTA Manager 108, and a local signaling manager 110. A call processing core is made up of a Call Engine 112 that may include a 3^{rd} Party Make Call Control (3PCC) API 114. Call services are provided through the switch, which may include a CSTA service 116 and other services as well 118.

The Web-based client 102 may include a user interface that allows the user to make calls and interact with the system. This may be a graphical user interface (GUI) that may be a browser running on a user's PC, for example. This could be a set of XML and JavaScript sent to it in real time from the server.

The phone 104 may be a standard SIP phone. While it is typically a separate phone device located on the users desk, it could also be a SIP telephony application running on the user's PC. For improved usability, the phone should be able to respond to various stimuli from the Softswitch in an automated manner. This is primarily to allow an auto-answer, such as causing the phone to go off-hook in a speakerphone mode).

The server 106 translates user requests into CSTA messages going to the switch 112 and acts on CSTA messages from the switch and sends the appropriate XML/JavaScript to the client at the end user location. The core of the server 106 are existing functions known to those skilled in the art.

The CSTA manager 108 acts as a signaling proxy for the user's telephone 104, shown in the figure as an SIP phone. The CSTA manager 110 further acts as a “thin” SM, basically providing for the conversion of CSTA messages to/from the internal messages to the SIP SM. In performing these functions, may make use of the Call Engine's 3PCC API functions (for the Make Call), along with new messages to the SIP SM.

As CSTA messages arrive from the server 106, the CSTA Manager 108 takes one of two actions. If it is a Make Call, the CSTA Manager 108 will send the existing Setup Request message to the Call Engine for processing. This message was first introduced for the TCAP Automatic Callback feature, and should require little or no changes. For all other messages, CSTA Manager 108 converts the functional CSTA message into the appropriate digits for an access code and send that access code (and other digits as required—for example, a DN) to the local signaling manager 110, which will perform basically normal signaling then into the Call Engine (see below). Since this is a brand new function, in addition to being a new Manager, a new Real-Time Transport Protocol (RTP) message will be added to send the access codes to the local signaling manager 110. Either CSTA Manager or CSTA Service should validate the user for each received message.

The local signaling manager 110, which may be a Session Initiation Protocol (SIP) Signaling Manager (SM), controls the signaling for setting up calls of a user agent client. When a caller (or User Agent Client) sends a request with the SIP URL of the called party, the SM sets up a session. The server will attempt to resolve the called user's location and send the request to them. the user's telephony client receives the request, that is, the user's phone rings. If the user takes the call, the client responds to the invitation with the designated capabilities of the client software and a connection is established. If the user declines the call, the session can be redirected to a voice mail server or to another user.

The local signaling manager 110 is enhanced to support receipt of signaling input not only from the telephone 104, but now, also from the phone's proxy, the CSTA Manager 108. When these messages are received, local signaling manager 110 will process them as though the SIP phone had sent them in, adjusting states as required and sending the normal set of the Call Engine messages into the Call Engine. Other local signaling managers should implement similar changes to allow the invention to act as a proxy for their users.

The Call Engine 112 is enhanced to support the modified Call Engine message used, for example, by CSTA. The Call Engine 112 integrates the 3PCC Make Call within itself, providing for the sequencing and control of the operations required. Internally, the Call Engine has minimal changes. It is enhanced to allow proper translation, routing, restrictions, and AMA for 3PCC calls. For example, for a simple A-to-B call, the Call Engine 112 translates the dialed digits and routes the call as though the A-party line was directly dialing the B-party. The Call Engine 112 established restrictions applied as though the A-party line was directly dialing the B-party.

Normal features and/or services and their operation and interactions are considered completely compatible with the present invention. Other than the Make Call function, other inputs into the Call Engine 112 are through the normal messaging from the SM. This allows for total transparency of features and their operation to the end user.

To allow the CSTA Manager 108 to convert the functional messages received into access codes, the CSTA is programmed according to the following. Given the identity of the originating line and a logical function (such as Hold), the CSTA Manager 108 returns the access code digit string. While performing this function, it takes into account whether or not the user belongs to a Centrex group in determining the access code. It returns either the string of digits for the access code (presumably, if the Craft has created an access code for the given feature) or will return a Not Found indication if the access code has not been created. Checks as to whether or not it is valid for the given user to use the requested feature occur in the normal location within Call Engine 112 when the SM sends the digits into the Call Engine 112.

Now, the operation of the invention according to the architectural diagram shown in FIG. 1 will be described. A call event from the external application is received by the CSTA manager 108, who sends an event to the local signaling manager 110, requesting that it operate as though it has received it via the normal interface. The local signaling manager 110 then controls the feature in the existing manner, allowing the existing feature segments in the call to operate in their normal manner. In this way, new code is not written to duplicate those existing features. The CSTA Service provides for the monitoring functionality required by all phone users. Following the first logon by each user following system start, the CSTA Service will have an active monitor on the line being proxied by each the phone application, and will report all events to/from that line to CSTA Manager.

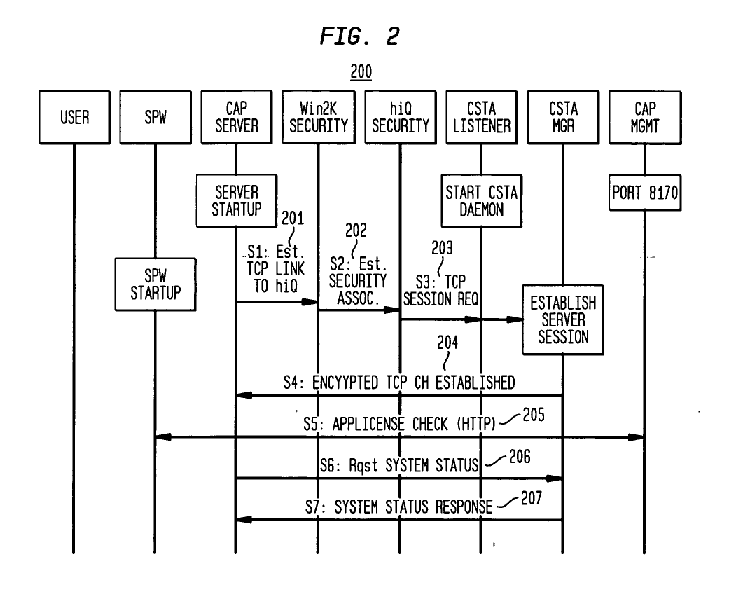

The several FIGS. 2-23 illustrate the external message flows between the new/impacted subsystems and the impact to the software architecture on a subsystem and a component level shall be understood from the following description.

In FIGS. 2-4, the Initialization and Logon Message Flows will be discussed that initialize the system and provide for logon and logoff are set forth. In FIG. 2, a CAP Server Initialization Flow 200 is shown showing the server startup. A signal 201 is sent at server startup to a security element, such as a Win2K Security element, that establishes a communication link, here shown as TCP, to the Softswitch. After establishing a secure connection, the security element sends a signal 202 to the Softswitch confirming the secure connection. The Softswitch sends a TCP session request 203 to the called party, here the CSTA listener, and a corresponding CSTA daemon is started. The request 203 is forwarded to the CSTA manager and the server session is established.

In response to the request, the signal 204 indicating that an encrypted channel is established is sent from the CSTA-manager to the server. In one aspect, there may be an application license check, as indicated by a signal 205, between the telephone and CAP-manager. A signal 206 requesting a system status is sent from the CAP-server to the CSTA-manager and the switch responds with the current system status as indicated by the signal 207. In this manner is the initialisation for the system illustrated in FIG. 1 provided.

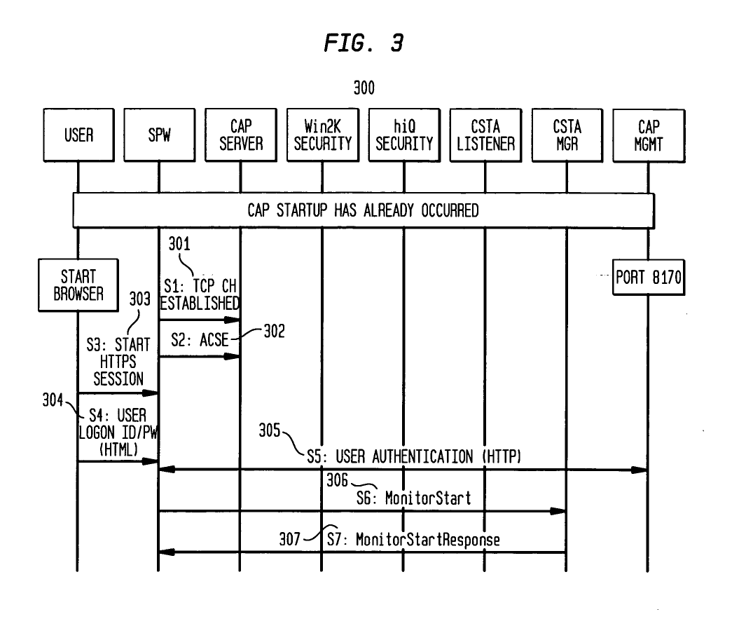

Now, the per-user initialisation flow 300 shall be described with reference to FIG. 3. The phone sends a signal 301 to establish a TCP-channel to the server. The phone further sends an ACE-signal 302 to server. Then, the user browser starts a session as indicated by the signal 303. The signal 304 forwards the user log-on ID to the phone. The signal 305 indicates the user identification between the CAP and the phone. The phone application sends a monitor start request on the telephone extension number or URI associated with the user log-on and password as indicated by the signal 306. The system responds with a monitor start response signal 307 containing a monitor reference ID and the call flow is complete.

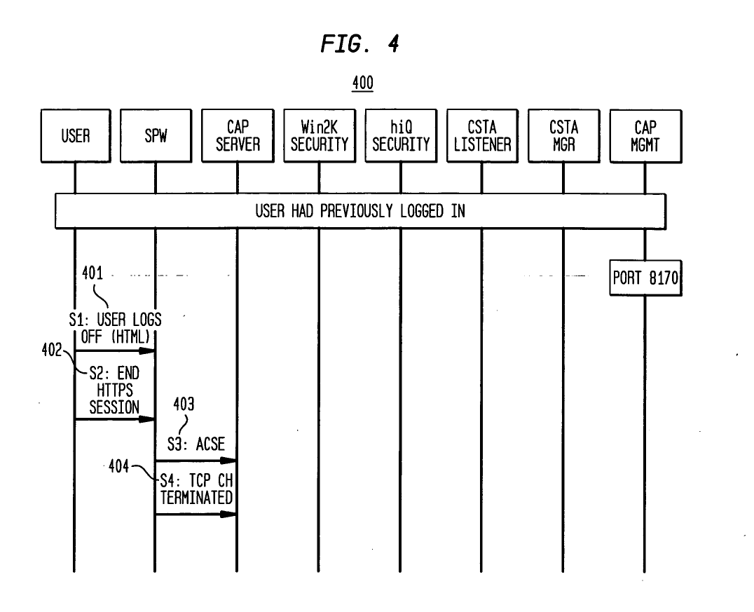

Now with respect to FIG. 4, the per-user log off flow 400 will be discussed. The user logs off and a signal 401 is sent from the user to the phone. A signal that ends the session is also sent from the user to the phone as indicated by the reference 402. The ACSE-signal 403 is sent from the phone to the server and the TCP-channel is terminated as indicated by the signal 404. It shall be appreciated that, in the invention, the CSTA-manager and service are not informed of the user log off and continue to report normally to the phone and the CAP-server.

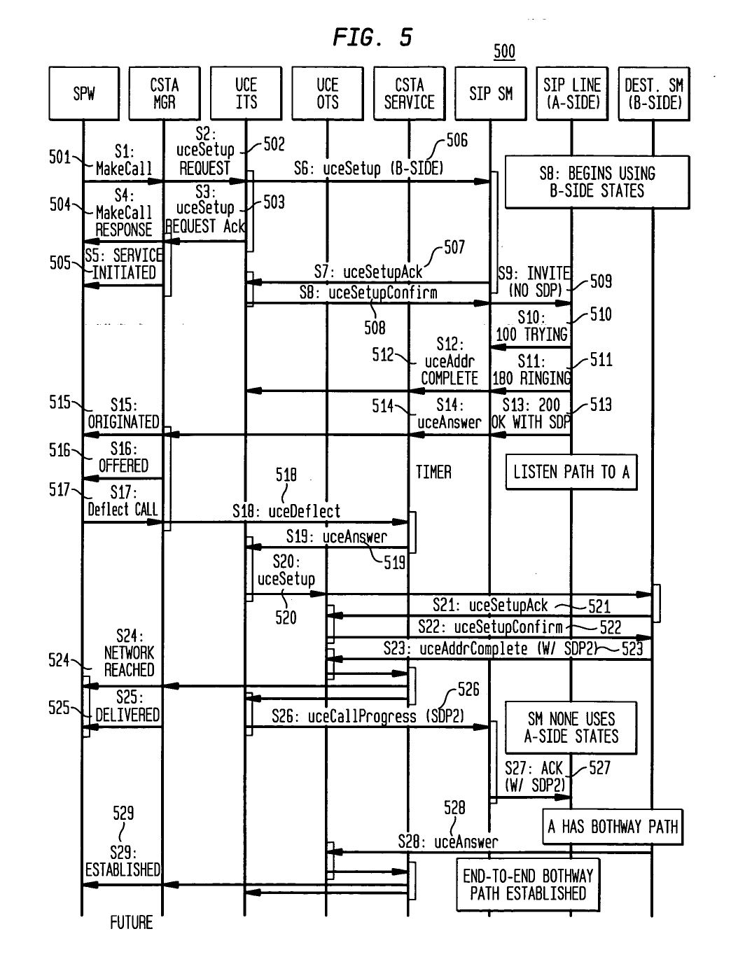

Now with respect to the FIGS. 5-9, the CSTA-basic call-flows will be discussed. It shall be appreciated that the basic call flows are described with reference to standard call flows, but that other signalling may be implemented than that described here. In FIG. 5, the call origination using the phone call flow 500 will be described. It should be appreciated from this call-flow, that the present invention continues to be sent events to the CSTA-manager from the CSTA-service during the processing of the call. Now, turning to FIG. 5, the phone sends a make call signal 501 to the CSTA-manager, for example, when the user selects a number and clicks the Make Call function to initiate this sequence. In response, CSTA-manager sends a set up request to the Call Engine to place the call to the parties to be connected. The set up request message exists in the known protocol and is utilized in the present invention for the TCAP third party call control. In response to the set up request signal 502, the switch begins the set up of the call by initiating a call to the phone associated the SIP-user. In case the phone is in an idle state, there may be included an original automatic speaker phone enable mode that automatically enables the phone.

Continuing with FIG. 5, the Call Engine then sends a set up request acknowledge 503 signal in response to the CSTA-manager. This response contains a context ID, which is the unique identifier that allows subsequent messages to be properly associated with this call. The CSTA-manager responds to the make call by providing a call ID signal 504 that is utilized for reference by the phone. The CSTA-manager then sends a service initiated signal 505 that indicates that a telephony service has been initiated at a monitored device. This event is commonly generated when a service or feature pumped the user to take a phone off-hook and that phone is not able to do so without manual intervention. The service is initiated also when a make call or consultation call service has been invoked and the originating device is initiating a new call that is associated with the request. In another instance, the service is initiated when a device is taken off-hook manually. The Call Engine then sends a set up signal 506 to the local signaling manager when the routing detects that the destination device is a SIP-device.

Although ITS is being used (as the SIP line is the initiator of the call), the local signaling manager is initially told to use B-side states. This changes later in the processing of the call. It shall be noted that, although the originator is originally using B-side states, all generated CDR records show the originator as the A-side of the call. The local signaling manager sends a Setup Acknowledge signal 507 to the Call Engine according to known processing methodology. The Call Engine then sends a confirm signal to the local signaling manager according to normal processing. The local signaling manager sends an Invite signal 509 to a user. For example, the local signaling manager sends the Invite signal to user A containing no SDP media stream specifications, in accordance with RFC3264, but with a Require header indicating that preconditions are required. It is expected that the phone will respond with an offer in a 1xx including the media streams it wishes to use for the call. The phone responds with a TRYING signal 510 and then initiates a ringing signal 511 such as a 180 Ringing. 183 Ringing with early media is also an option.

To continue, the local signaling manager sends an address complete signal 512 to the CSTA service, the Call Engine and CSTA manager. In the context of the basic call flow the message carries a RINGING indicator in the m_eventType field. If the phone sends a 183 response, on the other hand then the message will carry the SDP media data. The SIP line sends an ok signal 513 to the local signaling manager. The originator answers the telephone. If not already sent, this message contains the SDP media data. The local signaling manager sends an Answer 514 to the CSTA service. If not already sent, this message contains the SDP media data. CSTA Service sets a timer waiting for a response from The CSTA Manager. If it times out, then the Answer is passed on to ITS with the original A side information. Alternatively, the CSTA service sends an answer, if not already sent, which message contains the SDP media data.

The CSTA manager in one aspect, generates the Originated event towards the PC application, and immediately generates a deflect signal back to CSTA Service containing the same calling party ID as in the answer. In an another variant, the CSTA manager generates the originated event and the offered event towards PC application.

Further continuing with FIG. 5, the CSTA manager sends an originated signal 515 to the phone. This event typically indicates that dialing is complete. It will be generated when the originating terminal goes off-hook, either automatically or manually.

It should be noted that the invention applies to various call models. One model logically separates each SIP device into the endpoint device (representing the user) and a separate Routing Device (representing the Virtual Assistant of the user). The first model expects the opportunity to deflect the outgoing call at this point 516 in the call flow of FIG. 5. This model may be based, for example, on the known OpenScape application.

In another model, the phone does not expect an offered signal at this point. This second call model may be the SPW call model, for example. To accommodate both models, the CSTA manager operates in one of two modes, on a device by device basis. In accordance with the first model, the call flow may elect to deflect or terminate the call at this point. When received, the local signaling manager sends the deflect signal 517.

The CSTA manager either automatically sends the Deflect signal 518 or upon receiving the deflect call. This message contains the (possibly new) A-side destination for the call. If the number is unchanged, the call will proceed to be set up to the B-party. If it has a new A-Party, it will require the Call Engine to tear down the existing half-call to the SIP line, and re-translate towards a different A-party, prior to completing the call to the originally requested B-party.

If not already sent, the CSTA service sends a message 519 that contains the SDP media data. In addition to indicating the answer of the (soon to be) A-side of the call, this message initiates the making of the call to the B-side. The Call Engine then sends a setup signal 520 according to normal processing. The setup contains the relevant SDP1 data from the caller telephone. A setup acknowledge signal 521 is sent to the Call Engine according to normal processing. The setup confirm signal 522 is sent to the local signaling manager according to normal processing.

The local signaling manager sends an address complete signal 523 according to normal processing. In one aspect, the Message carries a RINGING indicator in the m_eventType field. If the phone sends a 183 response, then it will carry the SDP media data.

In one example, an Address Complete signal may be triggered by, for example an SS7 ACM. The Address Complete signal normally establishes a 1-way talk path from called destination to the caller, so that the caller will hear the called party answer. The talk path from the caller to called party is withheld until the answer signal is received. The trunk gateway (in this example) will direct the 1-way path to the address specified in SDP1.

The Call Engine sends an address complete signal 523, as an alternative, to the CSTA service. The CSTA service uses this message to notify the CSTA manager that the call has progressed, and sends it on to the Call Engine for further processing. If the phone sends a 183 response, then it will carry the SDP media data.

The CSTA manager sends a Network Reached signal 524 to the phone application. This message is generated when an external gateway circuit, as opposed to the final destination, is reached successfully. If this had been to a subscriber on the same switch, this message would not have been present. In response to the address complete indication, the CSTA manager sends a delivered event signal 525 to the phone application. At this point, a list path exists so that the caller (phone A) can hear a ringback tone from the PSTN. Upon receiving the address complete, the Call Engine generates the Call Progress signal 526 to the local signaling manager. This informs the local signaling manager of the value of the B-side SDP (enabling a two-way path), along with causing it to switch over using A-side states.

The local signaling manager sends an acknowledge signal 527 for the SIP Line. The SIP SM converts the Call Progress signal into a SIP ACK message, containing the SDP2 of the destination to permit a two-way path. Other elements in the network should prevent an end-to-end talk path (A to DEST) until an answer signal is detected. When the remote party has answered, the local signaling manager will send an answer signal 528 to the Call Engine, and the CSTA manager. The phone application is notified of a successful connection via an established signal 529 sent from the CSTA manager.

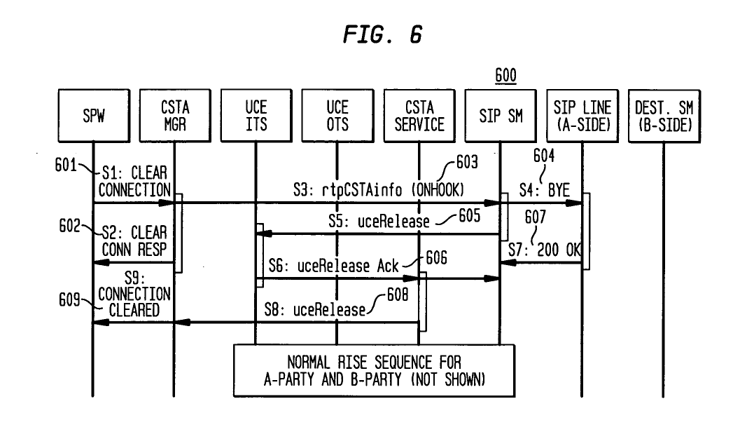

Now with reference to FIG. 6, the call flow 600 for call release will be discussed. In order to release the phone, the phone application signal 601 is sent to the CSTA manager. For example, the user clicks an icon in the web browser to release the existing connection. This connection release is directed to the call leg of the telephone. In a two party call this will trigger a call release. The call ID and device ID are utilized to permit identification of the proper CA instance and call record.

The CSTA manager sends a clear connection signal 602 to the phone application as a standard response. Since all parameters are optional, the phone application accepts an empty element tag. In response to the user request, the CSTA manager sends an RTP info signal 603 to the local signaling manager indicating an on-hook state. Based on that, the local signaling manager clears the call towards the phone (with a BYE signal 604) and towards the switch with a Release signal 605. The BYE signal 604 is sent from the local signaling manager to the SIP line according to normal processing. The release signal 605 is sent from the phone to the Call Engine also according to normal processing. The Release acknowledge 606 is sent from the Call Engine to the service and local signaling manager according to normal processing.

When the service receives the message, it forwards the message on to the local signaling manager, along with sending a release to the CSTA manager. The OK signal 607 is sent from the SIP line to the local signaling manager according to normal processing. The service sends a release 608 to the CSTA manager to indicate that the existing connection has been cleared. The CSTA manager sends a connection cleared event 609 to the phone application in response and the Call Release procedure is complete.

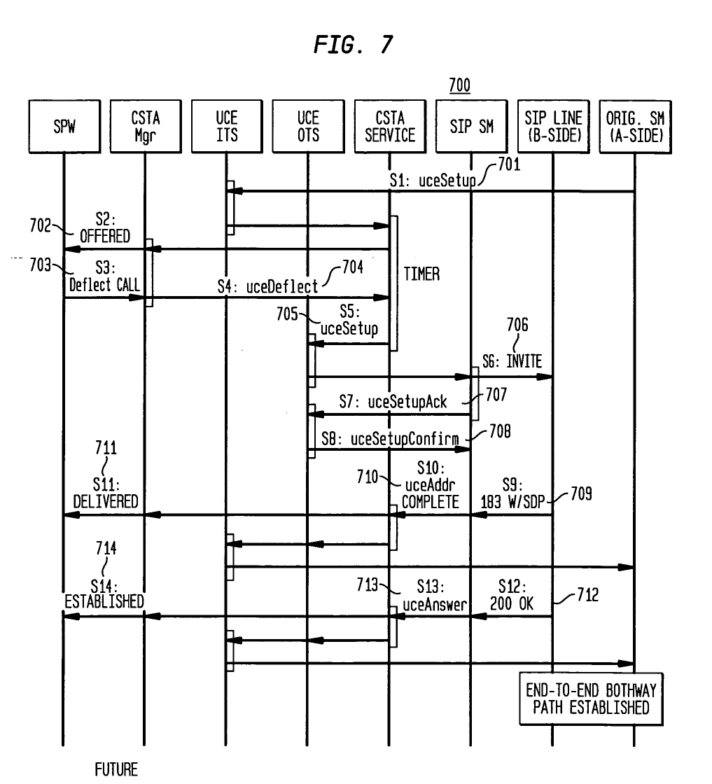

The incoming call handling 700 call flow using the phone application will be discussed with reference to FIG. 7. The local signaling manager sends a setup signal 701 to the Call Engine according to normal processing. ITS and AS components process the incoming call and determine that the destination is a SIP device (the one currently being monitored). Alternatively the Call Engine sends the setup 701 to the service, as it has an active monitor on the destination SIP line. The Service in turn sends the message to CSTA manager to determine the next steps. Optionally, the Service sets a safeguarding timer that keeps track of how long a response takes in order that the Service may take further action in the event that a response is not received.

As another option, and based on the PC application running determined by the initial Monitor Start request, CSTA manager uses this event slightly differently. For phone applications such as the phone application, it generates the Offered event towards the PC application, and immediately generates a Deflect signal back to CSTA Service containing the same called party id as in the Setup.

For others, such as OpenScape, the CSTA manager generates the Offered event and waits for a Deflect Call from the PC. The CSTA manager sends an Offered signal 702 to the phone application. This message indicates to the PC that an incoming call is arriving, so that, for example, the user can be notified.

In the event that the call is deflected (signal 703) to a destination other than the phone application user SIP device, the system will respond with a DEFLECTED event and subsequent monitoring and control of the call will not occur via CSTA. In the event that the call will be permitted to “ring through” to the SIP device, the CSTA application must be able to subsequently control the connection. For example, while the call is alerting the SIP device, the phone application user may decide to divert the call to a different destination via the browser interface. After answer at the SIP device the phone application user must be able to hold, consult, and transfer, or release the call.

The CSTA manager then sends a deflect signal 704 to the service. This signal is sent either automatically or when the Deflect Call signal 703 is received based on the phone application. This message contains the B-side destination for the call. If the number is unchanged (as in this example),the call will proceed to be set up to the original B-party. In one optional release flow, such as when there is a new B-Party, the call is routed to that party.

The Setup signal 705 is sent from the Service to the Call Engine and then to local signaling manager, both of which process the termination attempt as normal. The local signaling manager then sends an invite signal 706 to the SIP line according to standard SIP signaling.

The local signaling manager then sends a Setup Acknowledge signal 707 to the Call Engine according to normal processing. The Call Engine then sends a Setup Confirm signal 708 to the local signaling manager also according to normal processing. The SIP line then sends a ringing signal to the local signaling manager according to normal processing. The local signaling manager sends an Address Complete signal 710 to the service according to normal processing. The Message, in this example, carries a RINGING indicator in m_eventType field. If the phone sends a 183 response, then it will carry the SDP media data. The Service sends the message on to CSTA manager to show that the call is proceeding. It then sends this message to the Call Engine OTS, from which point on the message is processed normally.

In response to the address complete indication, the CSTA manager sends a Delivered event 711 to the phone application. At this point, a list path exists so that the caller (phone A) can hear a ringback tone from the PSTN. The SIP line sends an OK signal 712 to the local signaling manager. If not already sent, this message contains the SDP media data. The local signaling manager sends an Answer 713 to the service. If not already sent, this message contains the SDP media data. The CSTA Service sends the Answer signal to the CSTA manager. If not already sent, this message contains the SDP media data. This message is processed normally within the Call Engine, going finally to the Originating local signaling manager. The incoming call handling is this complete and the phone application is notified of a successful connection according to the Establish signal 714 from the CSTA manager.

Now with reference to FIG. 8, the Call Origination call flow 800 will be described. The SIP line initiates an invite signal 801 to the local signaling manager according to normal processing. The local signaling manager sends a setup signal 802 to the CSTA service according to normal processing. The Service receives the event when it has a monitor active on the SIP line. The Service sends the setup signal to the CSTA Manager.

Based on the PC application running (determined by the initial Monitor Start request), The CSTA Manager processes this event differently. For one phone application, such as OpenScape, it generates the Service Initiated and Originated events towards the PC application, and immediately generates a Deflect Back signal to the Service containing the same calling party id as in the Setup. In another, it generates the Service Initiated, Originated, and Offered events towards the PC application.

The CSTA manager sends a service Initiated 803 to the phone application. The Service Initiated event indicates that a telephony service has been initiated at a monitored device. This event is generated, when a service prompts a user to take a phone off-hook and that phone is not able to do so without manual intervention. Alternatively, the event occurs when a Make Call or Consultation Call service has been invoked and the originating device is initiating a new call that is associated with the request. In another variant, the event occurs when a device is taken off-hook manually.

The CSTA manager sends an Originated signal 804 to the phone application. This event typically indicates that dialing is complete. It will be generated when the originating terminal goes off-hook, either automatically or manually. A Monitor Reference ID and call ID are the same as in previous CSTA event already described.

The CSTA manager sends an Offered signal 805 to the phone application. Different Phone Application may use different call models. One call model, OpenScape as already described, logically separates each SIP device into the endpoint device (representing the user) and a separate Routing Device (representing the Virtual Assistant of the user). This model expects the opportunity to deflect the outgoing call. Other models do not expect an Offered signal at this point. To accommodate both models, the CSTA Manager will operate in one of these two modes, on a device by device basis.

In accordance with the first call model the phone application may elect to deflect or terminate the call at this point by sending a Deflect call signal 806 to the CSTA manager. When received, the local signaling manager sends the Deflect signal. The CSTA Manager sends the Deflect signal 807 either automatically or upon receiving the Deflect Call. This message contains the A-Side destination for the call. If the number is unchanged (as in this example), the call will proceed to be set up to the B-party. Alternatively, if the call has a new A-Party, it will require the Call Engine to Fear down the existing half-call to the SIP line, and re-translate towards a different A-party, prior to completing the call to the originally requested B-party.

CSTA Service sends this setup message 808 on to the Call Engine. The Call Engine sends the setup signal 809 to both the Call Engine and to the local signaling manager normal processing. The Setup signal contains the relevant SDP1 data from the caller telephone. The local signaling manager sends a setup Acknowledge 810 to the Call Engine according to normal processing.

The Service sends a Release to The CSTA Manager to indicate that the existing connection has been cleared. The CSTA Manager sends a Connection Cleared event to the phone application.

The Call Engine sends a setup Confirm signal 811 to the resident manger according to normal processing. The local signaling manager sends an Address Complete signal 812 to the Call Engine according to normal processing. This Message carries RINGING indicator in m_eventType field. If the phone sends a 183 response, then it will carry the SDP media data.

Address complete may be triggered by, for example, an SS7 ACM. Address complete normally establishes a 1-way talk path from called destination to the caller, so that the caller will hear the called party answer. The talk path from the caller to called party is withheld until the answer signal is received. The trunk gateway (in this example) will direct the 1-way path to the address specified in SDP1.

Alternatively CSTA Service uses the Address Complete message to notify CSTA manager that the call has progressed, along with sending it on to ITS for further processing. For example, if the phone sends a 183 response, then it will carry the SDP media data.

A Network Reached message 813 is generated when an external gateway circuit is reached successfully, but not the final destination. In response to the address complete indication the CSTA manager sends a delivered event message 814 to the phone application.

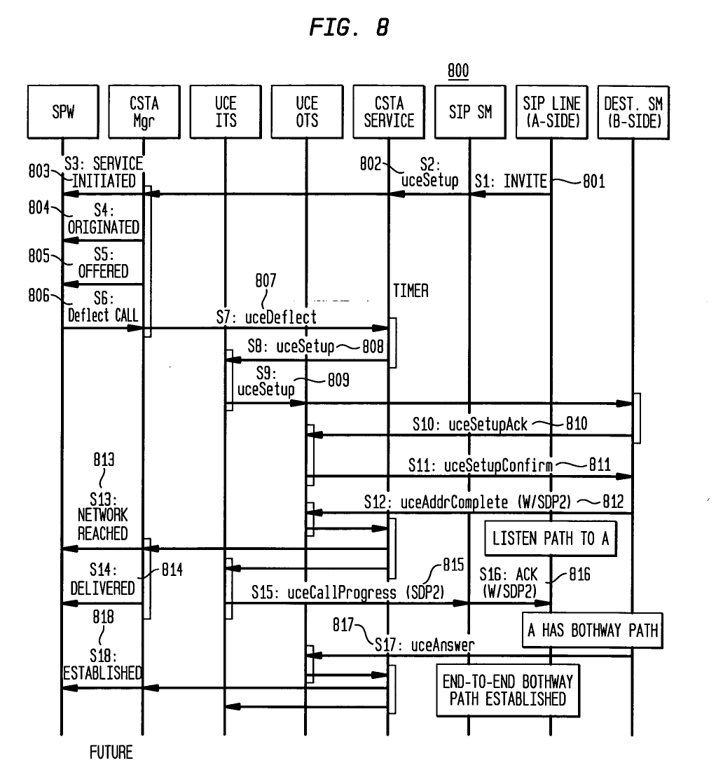

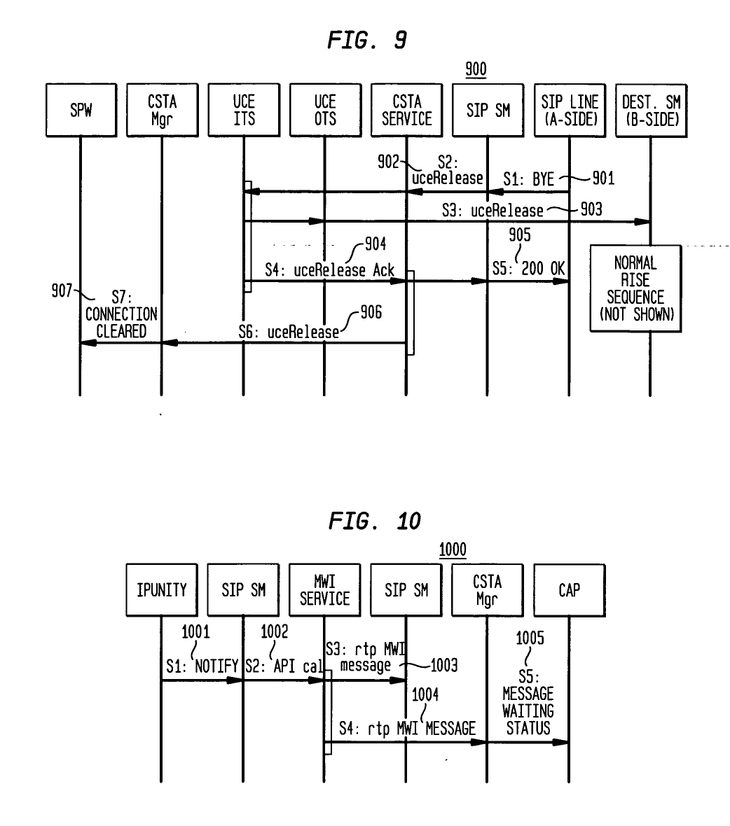

With respect to FIG. 9, the Call Release from phone 900 will now be described. First, the local signaling manager sends a BYE signal 901 to the SIP line according to normal processing. Then, the local signaling manager sends a Release 902 to the service according to passing it on to the Call Engine. In response to the SIP user disconnecting, the CSTA Service forwards the Release message 903 to the Call Engine to cause the call to the B-party to be disconnected. The Call Engine sends the Release to the local signaling manager for normal processing. When CSTA Service receives the message, it both forwards the message on to the local signaling manager, along with sending a Release 904 to the CSTA manager. The OK Signal 905 is then sent to the SIP line according to normal processing. Service sends a Release to CSTA manager to indicate that the existing connection has been cleared. The CSTA manager sends a Connection Cleared event 907 to the phone application.

When a call origination fails, such as when a busy line is detected on the B-side of the call, the Service will receive the Release Message sent to the Call Engine and will send it to two destinations. The first is to the Call Engine for normal processing. The second is to The CSTA Manager. When The CSTA Manager receives it, the CSTA manager will send a Failed event to the phone application. The user, upon getting a busy indication, will presumably need to clear the call.

The CSTA Feature Call Flows that are particularly relevant to the present invention shall now be discussed with respect to FIGS. 10-21. Now with reference to FIG. 10, the Message Waiting Indication (MWI) call flow 1000 shall be discussed. A Notify signal 1001 is sent from the IP unity to the local signaling manager to turn the MWI indication for a subscriber either on or off. The local signaling manager sends an API call signal 1002 to the MWI service be notified. The MWI service send an RTP MWI message 1003 to the local signaling manager (for the subscriber, in this case, a SIP line).

The MWI Service determines that there is a CSTA proxy for the phone line being notified, and sends an RTP MWI Message 1004 to the CSTA Manager. The CSTA Manager notifies, as indicated by 1005, the phone application that the MWI indication has been turned on or off thus indicating a Message Waiting.

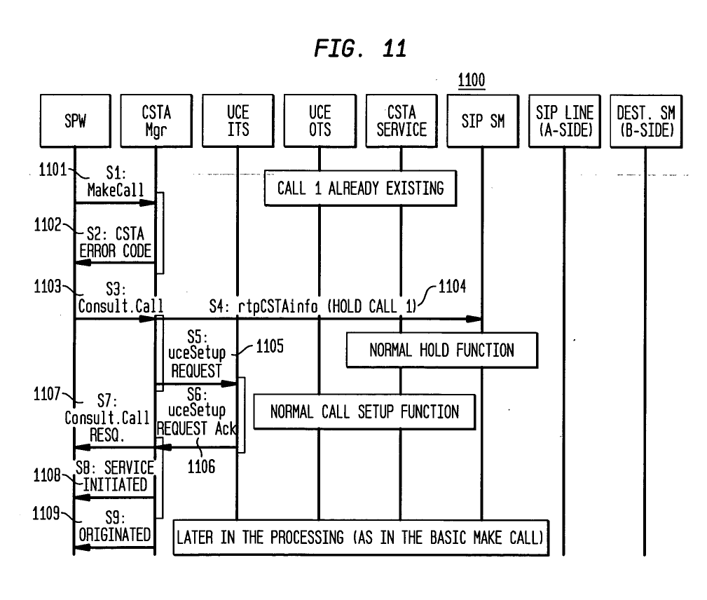

Now with reference to FIG. 11, a consultation call flow 1100 will now be discussed. In contrast to the normal Make Call case, this invention handles the situation when a first call has already been made, causing the second Make Call to be rejected and forcing the phone application to explicitly send in the Consultation Call. This call flow puts the first call on hold, then sets up the second call. First the local signaling manager sends the Make Call signal 1101 to the CSTA manager. For example, the user selects a number to consult and clicks the make call function to initiate this sequence. The message call flow proceeds according to the same as in the basic Make Call already discussed. The CSTA manager tells the phone application using an Error Code 1102 that it is not valid to make another call. In this example, this occurs because there is already an active call.

The phone application now sends a Consultation Call request 1103 to the CSTA manager. An example of the code employed for sending the request is given here:

```
<ConsultationCall>
    <existingCall>
        <callID>
            7497
        </callID>
        <deviceID typeOfNumber=“dialingNumber”>
            31779
        </deviceID>
    </existingCall>
    <consultedDevice>
        31756
    </consultedDevice>
</ConsultationCall>
```

As the first real step in performing a consult, the CSTA Manager puts the first call on hold by sending an information signal 1104 to the local signaling manager indicating a Hold access code. Based on the code the local signaling manager initiates a standard hold function. The CSTA Manager then initiates the new call as described in an earlier flow sending the setup Request to the Call Engine.

The Softswitch begins the setup of the call by responding to the Setup Request with an acknowledge signal 1106. Of significance in this response is the Context ID, which is the unique identifier that allows all of the subsequent messages to be properly associated with this call. The CSTA manager responds to the Consultation Call, providing a call ID 1107 to the phone application used in future call services.

A Service Initiated signal 1108 indicating that the service is initiated is sent from the CSTA manager to the phone application according to the Make Call call flow already described. The CSTA manager then sends an Originated signal 1109 to the phone application according to the already-described take call flow. In this manner is the Consult call flow complete.

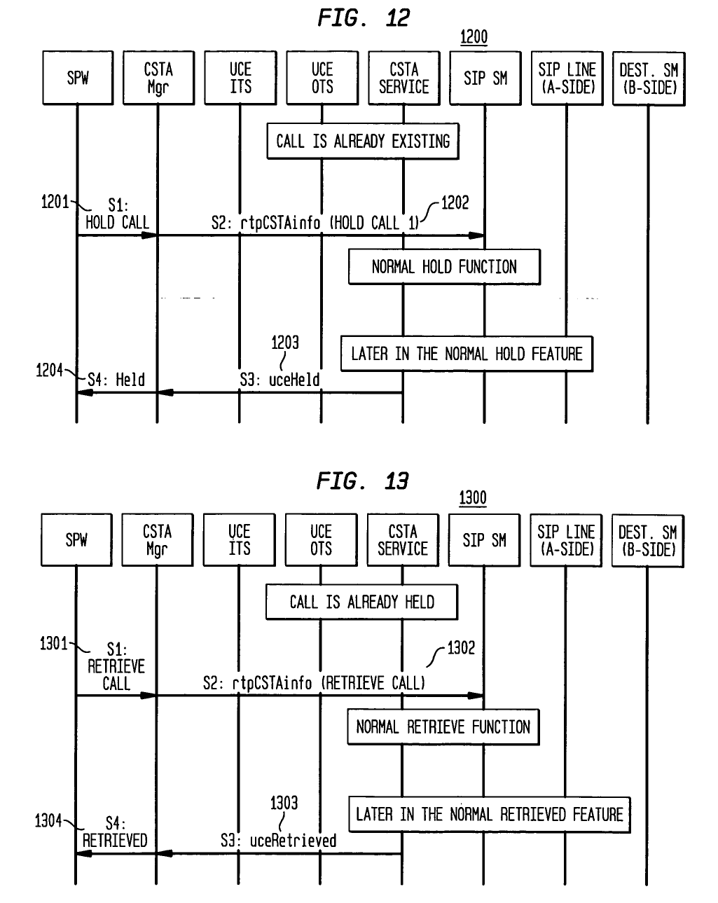

Now with respect to FIG. 12, the Hold Call call flow 1200 will be described. Based on the user choosing to hold a call, the phone application sends an Hold Call request 1201 to the CSTA manager.

In this example, the local signaling manager does not currently have an explicit Hold function, so this first message is not expected. However, the remainder of this flow is valid as part of both a Consultation Call and Alternate Call scenarios. The CSTA manager puts the call on hold by sending an Information signal 1202 to the local signaling manager providing the Hold access code. Based on that code, the local signaling manager initiates the hold function according normal procedures.

Later in the normal sequence of holding a call, CSTA Service is notified with a Held signal 1203. The CSTA Service sends the Held event to CSTA manager, notifying it that a line being proxyed by CSTA had a hold function performed on it. It shall be appreciated that this happens regardless of what initiated the hold. If the SIP phone initiated it, CSTA is notified in the same way. The CSTA Manager 1204 notifies the phone application that a call has been held. An example of the code employed for notifying the phone application of the call held is given here:

<HeldEvent>

<monitorCrossRefID>

19

</monitorCrossRefID>
<heldConnection>

<callID>

7498

</callID>
<deviceID typeOfNumber=“dialingNumber”>

31779

</deviceID>

</heldConnection>
<holdingDevice>

<deviceIdentifier typeOfNumber=“dialingNumber”>

31779

</deviceIdentifier>

</holdingDevice>
<localConnectionInfo>

hold

</localConnectionInfo>
<cause>

alternate [symbol] ===========various values based on the cause

another is “consultation”

</cause>

</HeldEvent>

Now with respect to FIG. 13, the Retrieve Call flow 1300 will now be discussed. Based on the user choosing to retrieve a call, the phone application sends a Retrieve Call request 1301. It shall be noted that the phone application does not currently have an explicit Retrieve function, so this first message is not expected. However, the remainder of this flow is valid as part of the Alternate Call scenario.

The CSTA Manager retrieves the call on hold by sending an Information signal 1302 to the local signaling manager indicating the Retrieve access code. Based on that, the local signaling manager initiates the retrieve function according to normal procedures. Later in the normal sequence of retrieving a call, CSTA Service is notified. It sends the Retrieve event to The CSTA Manager, notifying it that a line proxyed by CSTA 1303 had a retrieve function performed 01 it. In this example, this occurs regardless of what initiated the retrieve. If the phone initiated it, CSTA is notified in the same way. The CSTA Manager notifies (1304) the phone application that a call has been retrieved. An example of the code employed for notifying that a call has been retrieved is given here:

```
<RetrievedEvent>
    <monitorCrossRefID>
        19
    </monitorCrossRefID>
    <retrievedConnection>
        <callID>
            7497
        </callID>
        <deviceID typeOfNumber=“dialingNumber”>
            31779
        </deviceID>
    </retrievedConnection>
    <retrievingDevice>
        <deviceIdentifier typeOfNumber=“dialingNumber”>
            31779
        </deviceIdentifier>
    </retrievingDevice>
    <localConnectionInfo>
        connected
    </localConnectionInfo>
    <cause>
        alternate
    </cause>
</RetrievedEvent>
```

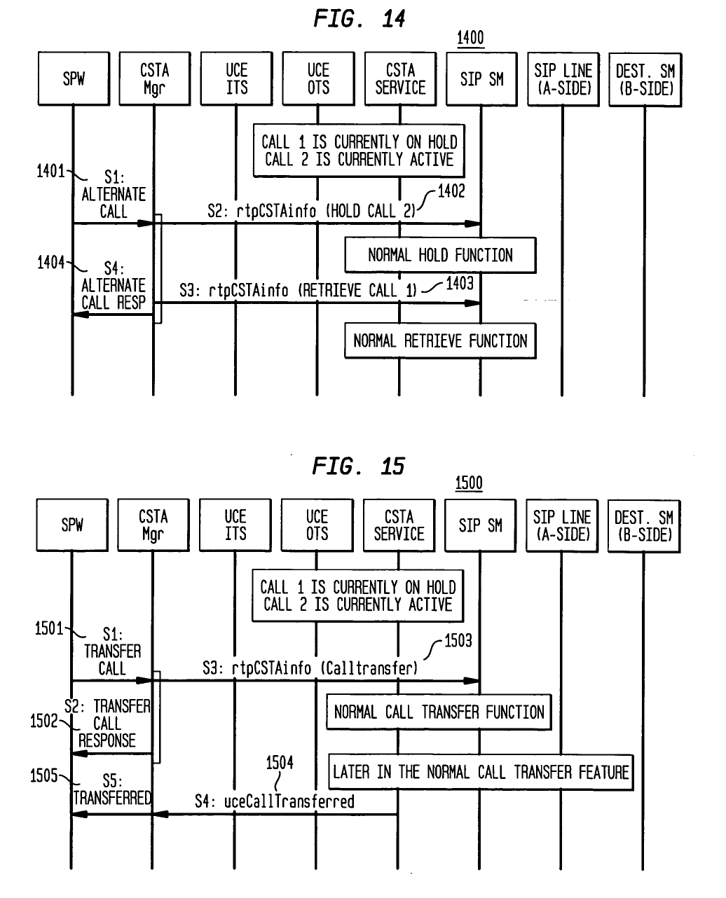

The Consultation Toggle call flow 1400 shall now be described with reference to FIG. 14. Based on the user choosing to toggle between two calls, the phone application sends in an Alternate Call request 1401. To toggle between the two calls, The CSTA Manager sends two events 1402, 1409 to the local signaling manager. The first puts the currently active call on hold. The second makes a previously held call active. CSTA messages for those two activities are shown in their respective flows (previously described). The CSTA Manager acknowledges the request as indicated by reference 1404 and the consultation Toggle is complete.

The supervised Call Transfer call flow 1500 using the Telephone application will now be discussed with reference to FIG. 15. Based on the phone application user choosing to transfer the held call party to the active call party the phone application sends a Transfer Call request 1501 to the CSTA manager. The CSTA Manager acknowledges the request with a Transfer Call Response 1502, providing a call that is needed for future reference. This may be accomplished in a similar manner as described in the Make Call procedure. To transfer the held call to the active call, the CSTA Manager sends an event 1503 to the local signaling manager with the transfer access code. Later in the normal sequence of transferring a call, the CSTA Service is notified. It sends the Call Transferred event 1504 to the CSTA Manager notifying it that a line being proxyed by CSTA had a Call Transfer function performed.

In one aspect this happens regardless of what initiated the call transfer. If the SIP phone initiated it, CSTA is notified in the same way. The CSTA Manager notifies the phone application that a call has been retrieved by way of a Transferred signal 1505. An example of the code employed for notifying the phone application that a call has been retrieved is given here:

```
<TransferedEvent>
    <monitorCrossRefID>
        19
    </monitorCrossRefID>
    <primaryOldCall>
        <callID>
            7497
        </callID>
        <deviceID typeOfNumber=“dialingNumber”>
            31779
        </deviceID>
    </primaryOldCall>
    <secondaryOldCall>
        <callID>
            7498
        </callID>
        <deviceID typeOfNumber=“dialingNumber”>
            31779
        </deviceID>
    </secondaryOldCall>
    <transferringDevice>
        <deviceIdentifier typeOfNumber=“dialingNumber”>
            31779
        </deviceIdentifier>
    </transferringDevice>
    <transferredToDevice>
        <deviceIdentifier typeOfNumber=“dialingNumber”>
            31756
        </deviceIdentifier>
    </transferredToDevice>
    <transferredConnections>
        <connectionListItem>
            <newConnection>
                <callID>
                    7501
            </callID>
            <deviceID typeOfNumber=“deviceNumber”>
                    134218325
                </deviceID>
            </newConnection>
            <endpoint>
                <deviceID typeOfNumber=“dialingNumber”>
                    31282
                </deviceID>
            </endpoint>
        </connectionListItem>
        <connectionListItem>
            <newConnection>
                <callID>
                    7501
                </callID>
                <deviceID typeOfNumber=“deviceNumber”>
                    134218403
                </deviceID>
            </newConnection>
            <endpoint>
                <deviceID typeOfNumber=“dialingNumber”>
                    31756
                </deviceID>
            </endpoint>
        </connectionListItem>
    </transferredConnections>
    <localConnectionInfo>
        null
    </localConnectionInfo>
    <cause>
        transfer
    </cause>
</TransferedEvent>
```

An Unsupervised (Ringing) Call Transfer using the phone application is performed in a similar manner to normal processing. In the supervised transfer of the invention, by contrast, the second call is still ringing. The other messages are the same for the unsupervised transfer.

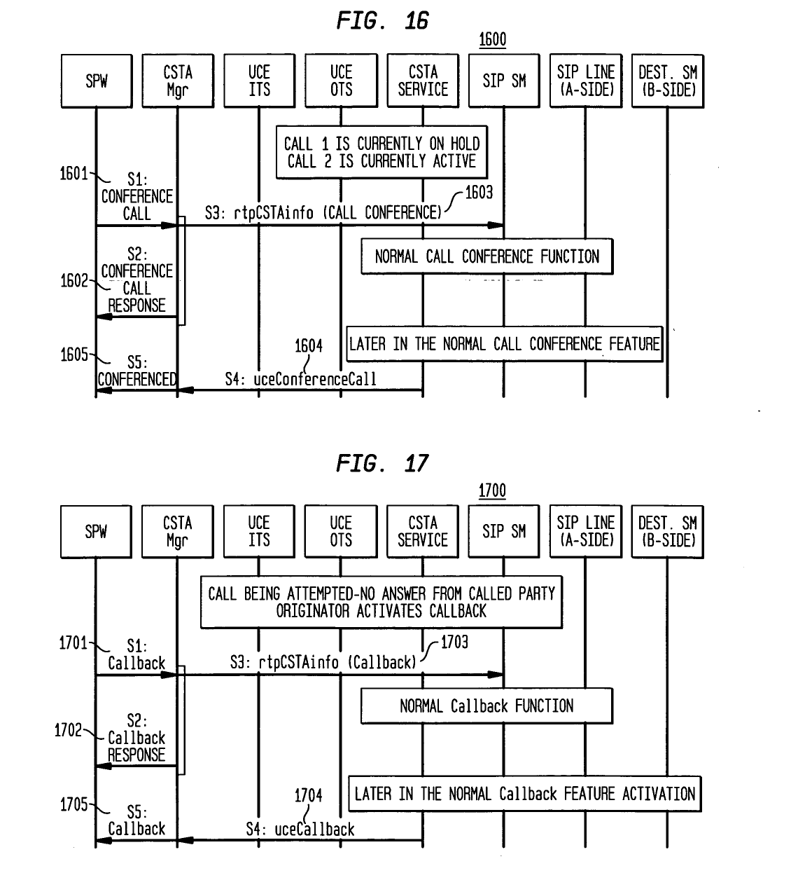

Now with reference to FIG. 16, the Conference Call call flow 1600 will be described. One skilled in the art will readily understand how the addition of a 4^{th} party to this conference and/or a dropping of a party from the conference by extrapolation of this call flow. Based on the user choosing to conference the held call party, to the active call party the phone application sends in an Conference Call request 1601 to the CSTA manager. The CSTA Manager acknowledges the request, providing a call ID 1 602 that is needed for future reference. In one aspect, the CSTA manager obtains the call ID in a similar manner as the Make Call call flow. To transfer the held call to the active call, the CSTA manager sends an event 1603 to the local signaling manager with the conference call access code. Later in the normal sequence of conferencing a call, the CSTA Service is notified. It sends the Conference Call event 1604 to CSTA manager, notifying it that a line being proxyed by CSTA had a Conference Call performed. It shall be noted that this happens regardless of what initiated the conference call. If the SIP phone initiated it, CSTA is notified in the same way. The CSTA manager notifies (1605) the phone application that a call has been conferenced. An example of the code employed for notifying the phone application that a call has been conferenced is given here:

```
<ConferencedEvent>
    <monitorCrossRefID>
        19
    </monitorCrossRefID>
    <primaryOldCall>
        <callID>
            7607
        </callID>
        <deviceID typeOfNumber=“dialingNumber”>
            31779
        </deviceID>
    </primaryOldCall>
    <secondaryOldCall>
        <callID>
            7609
        </callID>
        <deviceID typeOfNumber=“dialingNumber”>
            31779
        </deviceID>
    </secondaryOldCall>
    <conferencingDevice>
        <deviceIdentifier typeOfNumber=“dialingNumber”>
            31779
        </deviceIdentifier>
    </conferencingDevice>
    <addedParty>
        <deviceIdentifier typeOfNumber=“dialingNumber”>
            32078
        </deviceIdentifier>
    </addedParty>
    <conferenceConnections>
    <connectionListItem>
        <newConnection>
            <callID>
                7610
            </callID>
            <deviceID typeOfNumber=“dialingNumber”>
                31779
            </deviceID>
        </newConnection>
        <endpoint>
            <deviceID typeOfNumber=“dialingNumber”>
                31779
            </deviceID>
        </endpoint>
    </connectionListItem>
    <connectionListItem>
        <newConnection>
            <callID>
                7610
            </callID>
            <deviceID typeOfNumber=“dialingNumber”>
                32078
            </deviceID>
        </newConnection>
        <endpoint>
            <deviceID typeOfNumber=“dialingNumber”>
                32078
            </deviceID>
        </endpoint>
    </connectionListItem>
    <connectionListItem>
        <newConnection>
            <callID>
                    7610
            </callID>
            <deviceID typeOfNumber=“deviceNumber”>
                134218329
            </deviceID>
            </newConnection>
            <endpoint>
                <deviceID typeOfNumber=“dialingNumber”>
                    31282
                </deviceID>
            </endpoint>
        </connectionListItem>
    </conferenceConnections>
    <localConnectionInfo>
        connected
    </localConnectionInfo>
    <cause>
        normal
    </cause>
</ConferencedEvent>
```

Following the normal release of a call, if there is a Held call on the line, the normal Call Hold feature logic will cause the line to be re-rung. Thus, the conference call is established using the present invention.

Now with reference to FIG. 17, the Automatic Callback Request (Monitoring) call flow 1700 will now be discussed. Based on the user requesting a callback from the called party, the phone application Callback request 1701 to the CSTA manager. The CSTA manager acknowledges the request by sending a callback Response 1702 to the phone application. In this case the DN indicates that there is either no answer or a busy signal at the destination. To activate the callback, the CSTA manager sends an event 1703 to the phone application with the automatic callback access code. Later in the normal sequence of activating the automatic callback, the CSTA service is notified. It sends the Callback event 1704 to CSTA manager, notifying it that a line being proxyed by CSTA requesting an Automatic callback. In this example, this is set to occur regardless of what initiated the Automatic Callback. If the SIP phone initiated it, for example, CSTA is notified in the same way. The CSTA manger notifies the phone application (1705) that a dialed party has had automatic callback activated. An example of the code employed for notifying the phone application of an automatic callback activation is given here:

```
<CallBackEvent>
    <monitorCrossRefID>
        27
    </monitorCrossRefID>
    <originatingDevice>
        <deviceIdentifier typeOfNumber=“dialingNumber”>
            31779
        </deviceIdentifier>
    </originatingDevice>
    <targetDevice>
        <deviceIdentifier typeOfNumber=“dialingNumber”>
            31439
        </deviceIdentifier>
    </targetDevice>
    <callBackSetCanceled>
        1
    </callBackSetCanceled>
</CallBackEvent>
```

An Automatic Callback Call (monitoring) is handled according to a normal call initiated by the Automatic Callback Service. CSTA Service receives messages as in a call completing to an the phone-application-monitored line. In the events sent to the CSTA manager, an indication is provided that the reason for the event is a Callback, so that corresponding messages can have the appropriate Cause value set. These include the Service initiated, originated and delivered messages.

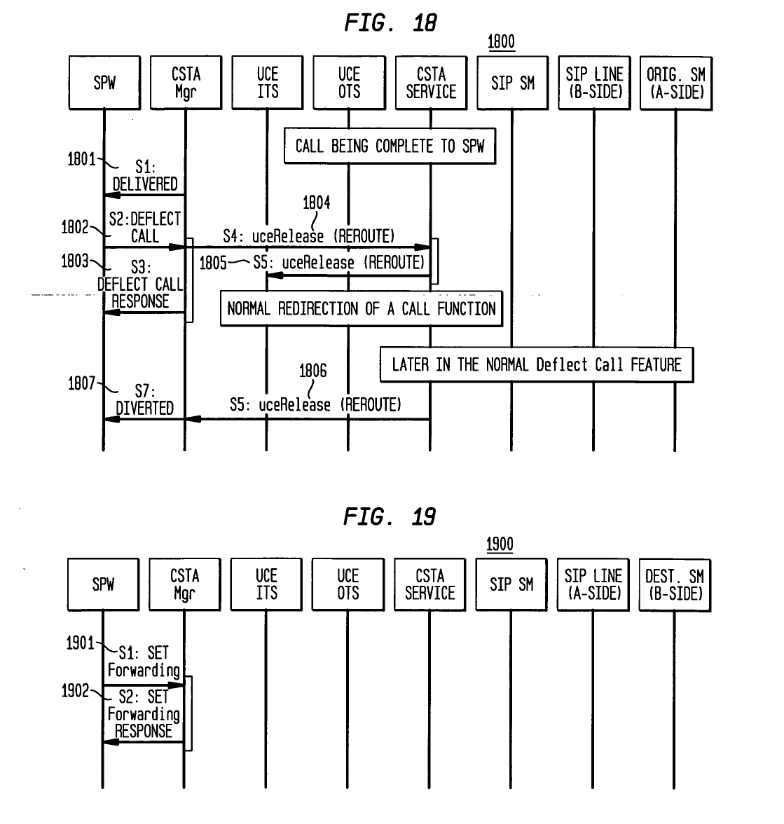

The Call Diverted call flow 1800 will now be described with reference to FIG. 18. The CSTA manager sends a delivered signal 1801 to the phone application using normal event notification to proxying a SIP line. If a user manually diverts a call, it will most likely happen after this event in the call as this is during the ringing cycle. In any case, the user has chosen to divert the call and the phone application sends a Deflect Call signal 1802 to the CSTA manager. In response, the CSTA manger sends a deflect call response (CSTA manger to the phone application) confirmation response 1803 back to the phone application. To perform the deflection, CSTA manger sends an event 1804 to the CSTA Service indication a reroute procedure and the number to reroute the call to.

The CSTA Service tells the Call Engine to perform the rerouting of the call by way of the Release-Reroute signal 1805. Later in the normal sequence of diverting a call (which includes releasing the call to the SIP line being proxyed and setting up the call to the divert-to number), CSTA Service is notified (1806). It sends the Release (reroute) event 815 to CSTA manager, notifying it that a line being proxyed by CSTA requested a call diversion. In this case, this occurs regardless of what initiated the Call Diversion. If the SIP phone initiated it, for example CSTA, is notified in the same way. The CSTA manger notifies the phone application (1807) that a call diversion has occurred on the line that it is proxying. An example of the code employed for notifying the CSTA of the diversion is given here:

<DivertedEvent>

<monitorCrossRefID>

23

</monitorCrossRefID>
<connection>

<callID>

8029

</callID>
<deviceID typeOfNumber=“dialingNumber”>

31779

</deviceID>

</connection>
<divertingDevice>

<deviceIdentifier typeOfNumber=“dialingNumber”>

31779

</deviceIdentifier>

</divertingDevice>
<newDestination>

<deviceIdentifier typeOfNumber=“dialingNumber”>

31439

</deviceIdentifier>

</newDestination>
<callingDevice>

<deviceIdentifier typeOfNumber=“dialingNumber”>

32078

</deviceIdentifier>

</callingDevice>
<calledDevice>

<deviceIdentifier typeOfNumber=“dialingNumber”>

31779

</deviceIdentifier>

</calledDevice>
<lastRedirectionDevice>

<notSpecified/>

</lastRedirectionDevice>
<localConnectionInfo>

null

</localConnectionInfo>
<cause>

redirected [symbol] ===========other values exist for call

forwarding
</cause>

</DivertedEvent>

Now with reference to FIG. 19, the Call Forwarding Activate/Deactivate call flow 1900 will be described. The phone application sends a Set Forwarding signal 1901 to the CSTA manger. This is performed in response to changing the user their Call Forwarding data on the phone application. The phone application sends a set forwarding response 1902 to the CSTA manger. CSTA manger calls a routine to save the call forwarding data, and returns this response to the phone application.

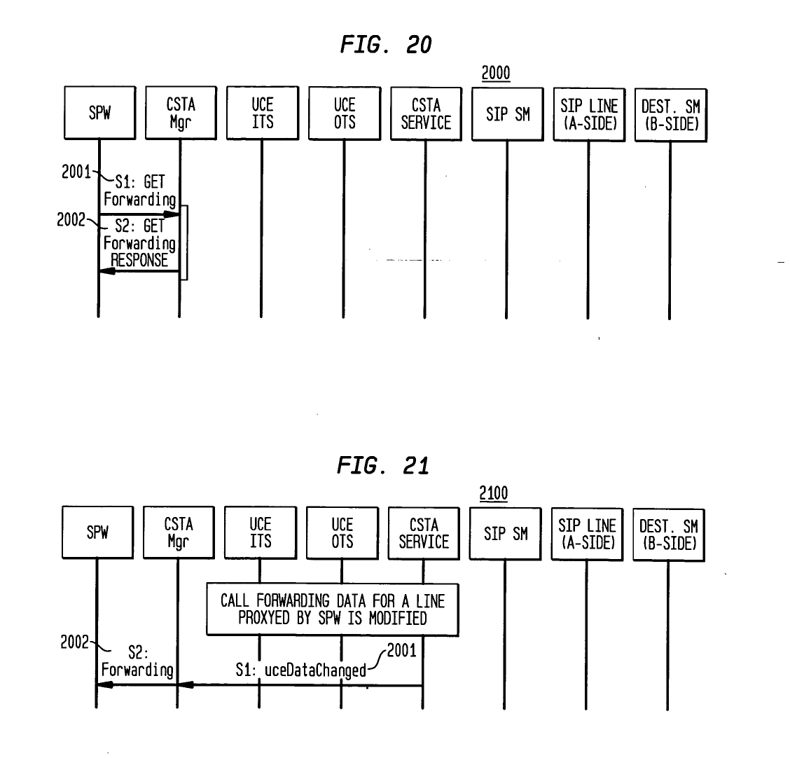

Now with respect to FIG. 20, the Call Forwarding Data Retrieval call flow 2000 will be discussed. This is triggered, for example, when the user clicks on an appropriate button provided by the phone application to retrieve current Call Forwarding data from the switch. In response, the phone application sends the Get Forward signal 2001 to the CSTA manager. The CSTA manager calls a routine to obtain the Call Forwarding data, and returns a Forwarding Response signal 2002 to the phone application and the Call Forwarding Data Retrieval is complete. An example of the code utilized to obtain the Call Forwarding data is given here:

```
<GetForwardingResponse>
    <forwardingList>
        <forwardListItem>
            <forwardingType>
                forwardNoAns
            </forwardingType>
            <forwardStatus>
                1
            </forwardStatus>
            <forwardDN typeOfNumber=“dialingNumber”>
                31996
            </forwardDN>
        </forwardListItem>
        <forwardListItem>
            <forwardingType>
                forwardBusy
            </forwardingType>
            <forwardStatus>
                1
            </forwardStatus>
            <forwardDN typeOfNumber=“dialingNumber”>
                31996
            </forwardDN>
        </forwardListItem>
        <forwardListItem>
            <forwardingType>
                forwardDND
            </forwardingType>
            <forwardStatus>
                1
            </forwardStatus>
            <forwardDN typeOfNumber=“dialingNumber“>
                31996
            </forwardDN>
        </forwardListItem>
    </forwardingList>
</GetForwardingResponse>
```

The Forwarding Data Change Reporting call flow 2100 will now be discussed with reference to FIG. 21. Any time that a phone proxyed by the phone application has its call forwarding data changed, the phone application receives a Forwarding event 2101. An example of the code utilized to receive the Forwarding event is given here:

```
<DivertedEvent>
    <monitorCrossRefID>
        23
    </monitorCrossRefID>
    <connection>
        <callID>
            8041
        </callID>
        <deviceID typeOfNumber=“dialingNumber”>
            31779
        </deviceID>
    </connection>
    <divertingDevice>
        <deviceIdentifier typeOfNumber=“dialingNumber”>
            31779
        </deviceIdentifier>
    </divertingDevice>
    <newDestination>
        <deviceIdentifier typeOfNumber=“dialingNumber”>
            31996
        </deviceIdentifier>
    </newDestination>
    <callingDevice>
        <deviceIdentifier typeOfNumber=“dialingNumber”>
            32078
        </deviceIdentifier>
    </callingDevice>
    <calledDevice>
        <deviceIdentifier typeOfNumber=“dialingNumber”>
            31779
        </deviceIdentifier>
    </calledDevice>
    <lastRedirectionDevice>
        <notSpecified/>
    </lastRedirectionDevice>
    <localConnectionInfo>
        null
    </localConnectionInfo>
    <cause>
        callForwardNoAnswer
    </cause>
</DivertedEvent>
```

The Call Origination to Line with Call Forwarding will now be briefly described. When a call diversion occurs in the switch CSTA Service will receive the Release (reroute) message sent to the Call Engine, and will send it to two destinations. The first is to Call Engine for normal processing. It will also be sent to CSTA manager. When CSTA manager receives the message, the CSTA manager will send a Diverted event to the phone application.

Although the present invention has been discussed with reference to specific examples and/or methodologies, it shall be appreciated that the invention encompasses the broader concepts set forth above and that modifications or variations of the invention may be practiced that are within the spirit and scope of the invention.

1. A method for providing call control functionality of call services to a user application platform of a user, the call services provided by a telephone network switch and allocated to a telephonic device of the user, the telephonic device coupled to a local signaling manager that provides signalling control to the telephone network switch and the user application platform coupled to a remote signalling manager that provides signalling control to the user application platform, comprising the steps of:
receiving a message by the remote signalling manager from the user application platform requesting a call service allocated to the telephonic device;
converting the message by the remote signaling manager into an access code into a format recognizable by the local signaling manager;
sending the access code to the local signaling manager coupled the telephonic device;
processing at the local signaling manager the access code; and
initiating by the local signaling manager the call service as indicated by the access code.

2. The method according to claim 1, further comprising the step of receiving a message by the remote signalling manager from the user application platform requesting a call set up.

3. The method according to claim 2, further comprising the step of sending a setup request message to the telephone network switch for normal call set up processing.

4. The method according to claim 1, further comprising the step of initiating by the local signaling manager call waiting as indicated by the access code.

5. The method according to claim 1, further comprising the step of initiating by the local signaling manager consultation call as indicated by the access code when a first call has already been made, causing a second call to be rejected.

6. The method according to claim 1, further comprising the step of initiating by the local signaling manager a retrieve call flow as indicated by the access code.

7. The method according to claim 1, further comprising the step of initiating by the local signaling manager a consultation toggle call as indicated by the access code.

8. The method according to claim 1, further comprising the step of initiating by the local signaling manager a supervised call transfer call as indicated by the access code.

9. The method according to claim 1, further comprising the step of initiating by the local signaling manager a conference call as indicated by the access code.

10. The method according to claim 1, further comprising the step of initiating by the local signaling manager an automatic callback request.

11. The method according to claim 1, further comprising the step of initiating by the local signaling manager activate/deactivate in response to the user changing a call forwarding data on the phone application.

12. The method according to claim 1, further comprising the step of initiating by the local signaling manager a call forwarding data retrieval when the user selects to retrieve current call forwarding data.

13. The method according to claim 1, further comprising the step of initiating by the local signaling manager a forwarding data change reporting when a phone proxyed by the phone application has its call forwarding data changed.

14. A system for providing call control functionality of call services to a user application platform of a user, the call services provided by a telephone network switch and allocated to a telephonic device of the user, comprising:
a local signalling manager coupled to the telephonic device that provides signalling control between the telephonic device and the telephone network switch;
a remote signalling manager coupled to the user application platform that provides signalling control to the user application platform;
wherein, the remote signalling manager converts a message received from the user application platform requesting a call service that is allocated to the telephonic device into an access code recognizable by the local signalling manager; and
wherein, the local signalling manager, in response to the message converted, requests the telephone network switch to provide the user application platform with the call service requested.

15. The system according to claim 14, wherein the remote signalling manager sends a setup request message to the telephone network switch for processing when a normal call is requested by the user.

16. The system according to claim 15, further comprising a personal computer (PC) that hosts the user application platform.

17. The system according to claim 14, wherein the telephone device is an SIP phone connected to the local signalling manager for establishing telephone calls of the user.

18. The system according to claim 14, wherein the telephone network switch is an HiQ8000 softswitch.
